(19) United States
(12) Patent Application Publication
(10) Pub. No.: US 2007/0250603 A1
(43) Pub. Date: Oct. 25, 2007

(54) System and method for enhancing DHCP and SNMP messages with RFID EPC ID

(75) Inventor: Weifan Enoch Suen, Irving, TX (US)

Correspondence Address: BAKER BOTTS, LLP, 910 LOUISIANA, HOUSTON, TX, 77002-4995, US

(73) Assignee: DELL PRODUCTS L.P., Round Rock, TX (US)

(21) Appl. No.: 11/407,463

(22) Filed: Apr. 20, 2006

(51) Int. Cl. G06F 15/177; G06F 15/173

(52) U.S. Cl. 709/220; 709/223

(57) ABSTRACT

A system and method for utilizing Electronic Product Code (EPC) information for configuring client components such as servers within a managed information handling system includes one or more client components (each including an EPC) connected with a management server. The management server communicates with an inventory database including a listing of EPCs and associated component characteristic information. When a client component requests a configuration message from the management server, the management server utilizes the EPC of the requesting client to determine the characteristic information associated with the client and generate an appropriate configuration message.

### TECHNICAL FIELD

The present invention is related to the field of computer systems and more specifically to a system and method for utilizing Electronic Product Code information within an information handling system.

### BACKGROUND OF THE INVENTION

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, integrated, or communicated, and how quickly and efficiently the information may be processed, stored, integrated, or communicated. The variations in information handling systems allow for information handling systems to be general or configured for a specific user or specific use such as financial transaction processing, airline reservations, enterprise data storage, asset management, or global communications. In addition, information handling systems may include a variety of hardware and software components that may be configured to process, store, and communicate information and may include one or more computer systems, data storage systems, and networking systems.

The management of components within information handling systems (such as servers, routers and other managed components) in an information handling system requires that such components be identified and integrated via standard protocols such as Internet Protocols (IP). Typically, managed components are identified using an IP address associated with the component. However, IP addresses are dynamic and do not provide any additional information related to the managed component. Also, there is currently no standard method or protocol to integrate and correlate identification information associated with various components of an information handling system: data such as IP addresses, Media Access Control (MAC) addresses, and Radio Frequency Identification (RFID) tags.

Additionally, the administrators of information handling systems often maintain a database containing inventory information of the components that are used by an organization's information handling system (or systems). Such an inventory database is often populated manually, requiring significant time and resources to create and maintain.

### SUMMARY OF THE INVENTION

Therefore a need has arisen for an improved system and method for efficiently and reliably identifying and integrating managed components.

A further need has arisen for an efficient system and method for building an asset inventory database.

The present disclosure describes a system and method for utilizing Electronic Product Code (EPC) information for configuring client components such as servers within a managed information handling system. Each client component includes an EPC as embedded in an RFID tag. Each client component is connected with a management server. The management server may communicate with an inventory database that includes a listing of EPCs and associated component characteristic information. When a client component requests a configuration message from the management server the management server utilizes the EPC of the requesting client to determine the characteristic information associated with the client and generate an appropriate configuration message.

In one aspect, the information handling system may include a management server and one or more client components in communication with the management server. The client components may each include an EPC associated therewith. The information handling system also includes an inventory database that is in communication with the management server and includes a listing of multiple EPCs and one or more component characteristic associated with each EPC entry. The management server manages the client components based upon the component characteristics obtained via each client component's EPC.

In another aspect of the present disclosure, a management server for managing client servers within an information handling system includes an electronic product code coordination module. The EPC coordination module is able to communicate with client servers that each include an electronic product code. The EPC coordination module may also communicate with an inventory database that lists a plurality of EPCs and at least one component characteristic associated with each EPC. The EPC coordination module is further able to provide each client server a configuration message incorporating the EPC of the client server and the characteristic information listed in the EPC.

In yet another aspect of the present disclosure a method is described that includes sending a request from a client component to a management server where the request includes an EPC associated with the client component. The method further includes retrieving one or more component characteristics based upon the EPC of the client component and then generating a configuration message to be sent to the client component that incorporates the EPC and the component characteristic information.

The present disclosure includes a number of important technical advantages. One important technical advantage is utilizing EPC information associated with each client component. The EPC allows for the efficient, reliable identification of the client components. The use of EPC information also allows for the population of an inventory database for use with the management server. This also fosters the construction of an asset inventory database for general use in managing an information handling system. Additional advantages will be apparent to those of skill in the art and from the figures, description and claims provided herein.

### BRIEF DESCRIPTION OF THE DRAWINGS

A more complete and thorough understanding of the present embodiments and advantages thereof may be acquired by referring to the following description taken in conjunction with the accompanying drawings, in which like reference numbers indicate like features, and wherein:

FIG. 1 shows an information handling system utilizing a management server inventory database according to teachings of the present disclosure;

FIG. 2 shows an inventory database table according to teachings of the present disclosure;

FIG. 3 shows a typical format of a Dynamic Host Control Protocol (DHCP) message;

FIG. 4 shows the typical format of an EPC tag;

FIG. 5 shows a flow chart of a method according to teachings of the present disclosure; and

FIG. 6 shows the encoding of an SNMP packet according to the present disclosure.

### DETAILED DESCRIPTION OF THE INVENTION

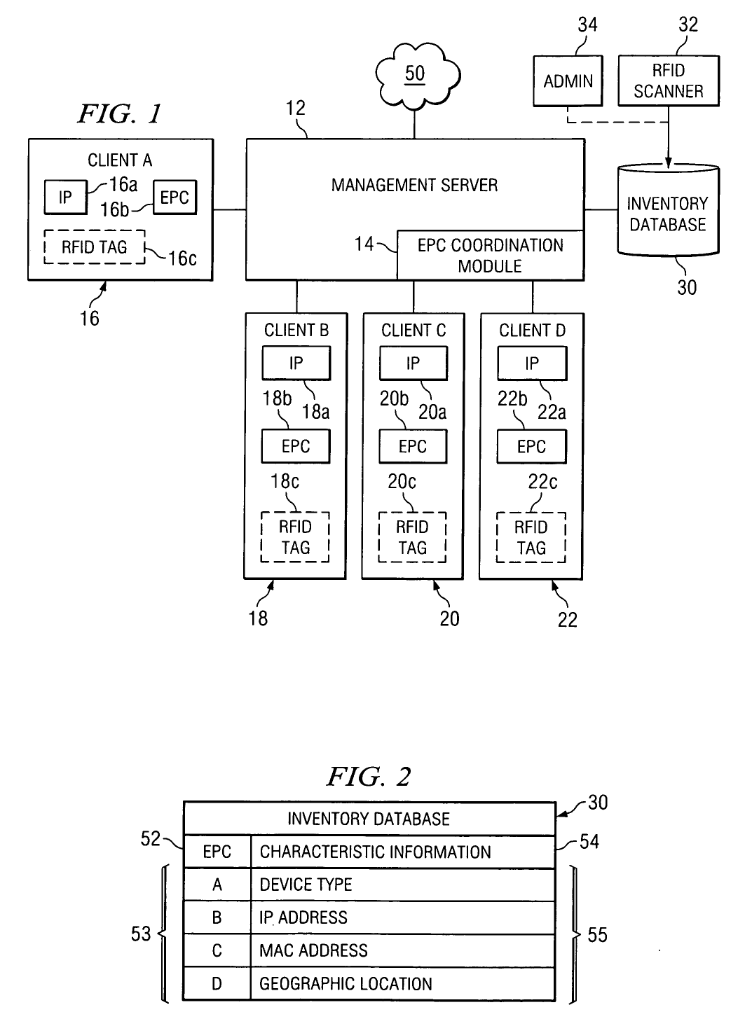

Preferred embodiments of the invention and its advantages are best understood by reference to FIGS. 1-6 wherein like numbers refer to like and corresponding parts and like element names to like and corresponding elements.

For purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, an information handling system may be a personal computer, a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a keyboard, a mouse, and a video display. The information handling system may also include one or more buses operable to transmit communications between the various hardware components.

Now referring to FIG. 1, an information handling system indicated generally at 10 is shown.

Information handling system 10 generally includes management server 12 in communication with client components 16, 18, 20 and 22. Management server 12 is further in communication with inventory database 30 and with network 50. In the present preferred embodiment management server 12 is a dynamic host configuration protocol (DHCP) server and includes an EPC coordination module 14. The DHCP protocol is describe in RFC2131, entitled Dynamic Host Configuration Protocol which is incorporated by reference, herein.

Client components 16, 18, 20 and 22 may also be referred to as a client server or a client and may comprise routers, database servers, main frame servers or any other suitable information handling system component that may be managed according to the present disclosure.

As shown in the present embodiment DHCP server 12 is in communication with inventory database 30 and client components 16, 18, 20 and 22. DHCP server 12 may be in communication with inventory database 30 via, for example, a Local Area Network (LAN) (not expressly shown). However, in alternate embodiments DHCP server 12 may be in communication with client components via a remote network connection and/or may be in communication with more or fewer client components. Additionally, management server 12 may be in communication with inventory database 30 via a network connection or may incorporate inventory database 30 within DHCP server 12.

As shown in the present embodiment, each client component 16, 18, 20 and 22 includes a data field for listing an IP address (16a, 18a, 20a and 22a) and a data field for listing an EPC associated with each client 16b, 18b, 20b and 22b. Client components 16, 18, 20 and 22 may also be referred to as a client server and may comprise any suitable network client. As part of the start-up process, client components 16, 18, 20 or 22 may communicate with management server 12 in order to obtain configuration information (including an IP network address). Each client is provided with a unique EPC. The unique EPC may be assigned during manufacture or may be assigned by a System Integrator that is able to overwrite an existing EPC with another selected EPC. Each client 16, 18, 20 and 22 is preferably operable to generate and send a request to management server 12 that incorporates each client's EPC.

As discussed herein, EPC is an identification scheme for universally identifying physical objects via Radio Frequency Identification (RFID) tags and other means. The EPC data for each client may be stored within persistent memory within each client such as within NVRAM. In the present embodiment, each client component 16, 18, 20 and 22 includes a corresponding RFID tag 16C, 18C, 20C and 22C.

For client systems that include a RFID tag such as tag 16C, as client system 16 is incorporated within information handling system 10, client system 16 may preferably be scanned by RFID scanner element 32 that is in communication with inventory database 30. RFID scanner 32 preferably reads the RFID tag of each client component to determine the EPC of such components. Administrator 34 may monitor the scanning of EPC information in this manner and further edit or add to information that is being entered into inventory database 30. Scanner 32 may preferably be placed at strategic locations, such as at then entrance of a data center, and may input geographical data coincident with reading the EPC. With the present application, inventory database 30 may contain not only the identification of the client systems, but also the location of the identified systems.

In the present embodiment DHCP server 12 includes EPC coordination module 14. EPC coordination module 14 represents any suitable hardware or software, including controlling logic, to carry out the functions described herein. The EPC coordination module 14 is preferably operable to communicate with client servers 16, 18, 20 and 22 and with the inventory database 30 and provide configuration messages to the client components. EPC coordination module 14 may preferably receive requests, including configuration requests, from client components 16, 18, 20 and 22 that include EPC information (16b, 18b, 20b or 22b) associated with each particular client. EPC coordination module further acts to retrieve component characteristics associated with each received EPC, from inventory database 30.

Additionally, EPC coordination module 14 acts to generate a configuration message to be sent to each requesting client server via, for example, either DHCP or SNMP, where the configuration message includes the EPC of the particular client and the component characteristic associated with the EPC. The component characteristic information may also be utilized by EPC coordination module 14 and/or management server 12 to manage the client component.

In operation when a new client component will be introduced within information handling system 10, the client component (in this example, client component 16) may be scanned using RFID scanner 32 in order to read RFID tag 16C and load EPC 16B and associated client characteristic information into inventory database 30. Alternately EPC information and client characteristic information may be entered manually or may be determined from another source such as via the mapping between a client's MAC address and EPC. After client component 16 is in communication with management server 12, client component may send a configuration request to management server 12 which may preferably be received by EPC coordination module 14. The request message includes EPC 16B. EPC coordination module 14 may then retrieve the component characteristics associated with the client component 16 from inventory database 30 using EPC 16B. EPC coordination module may then preferably generate a configuration message to be sent to client component 16 that incorporates the EPC and the at least one component characteristic.

The component characteristics (such characteristic information 54, discussed below) may include, for instance, geographic information (such as a location at which the RFID tag of a particular system was scanned), a component's MAC address, and authorization data (which may be obtained from an associated security database using the EPC as a key).

Now referring to FIG. 2, inventory database 30 is shown. Inventory database 30 on EPC column 52 listing a plurality of EPC values 53. In the present embodiment, EPC values 53 including values A-D, however, in alternate embodiments any suitable number of EPC values may be stored within inventory database 30. Inventory database also includes characteristic information column 54 and characteristic entries 55 (corresponding to EPC values 53). In the present embodiment characteristic entries 55 list a device type (such as whether the corresponding device is a router, a mainframe server, or a database server), an IP address of the corresponding device, a MAC address of the corresponding device or the geographic location of the corresponding device. The characteristic entries are exemplary and characteristic information 54 may include any suitable data. Additionally, characteristic information 54 may include only a single type of data (e.g., device type, geographic location, etc.) within a column. Characteristic information 54 may include multiple columns with each column populated with a different type of characteristic information for each device.

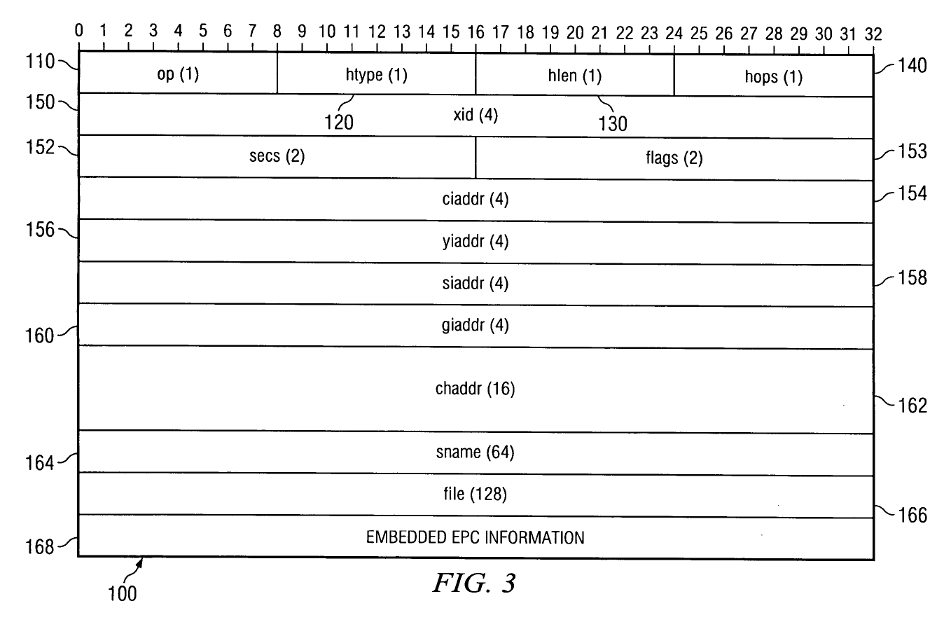

Now referring to FIG. 3, a diagram showing the typical format of a DHCP message is shown. DHCP message 100 includes: op (1) field 110, h-type field (1) 120, hlen field (1) 130 and hops field (1) 140. DHCP message 100 further includes: xid field (4) 160, secs field (2) 152, flags (2) field 153, ciaddr (4) field 154, yiaddr (4) field 156, siaddr(4) field 158, giaddr (4) field 160, chaddr (16) field 162, sname (64) field 164, file (128) field 166 and options field 168. In the present preferred embodiment options field 168 includes embedded EPC information for the appropriate client component. In other words, a DHCP message generated for client component 16 as shown in FIG. 1 would incorporate EPC information 16B within options field 168. In a particular embodiment a DHCP message generated for client 16 is formed in compliance with RFC2132, “DHCP Options and BOOTP Vendor Extensions” by S. Alexander and R. Droms, which is hereby incorporated by reference.

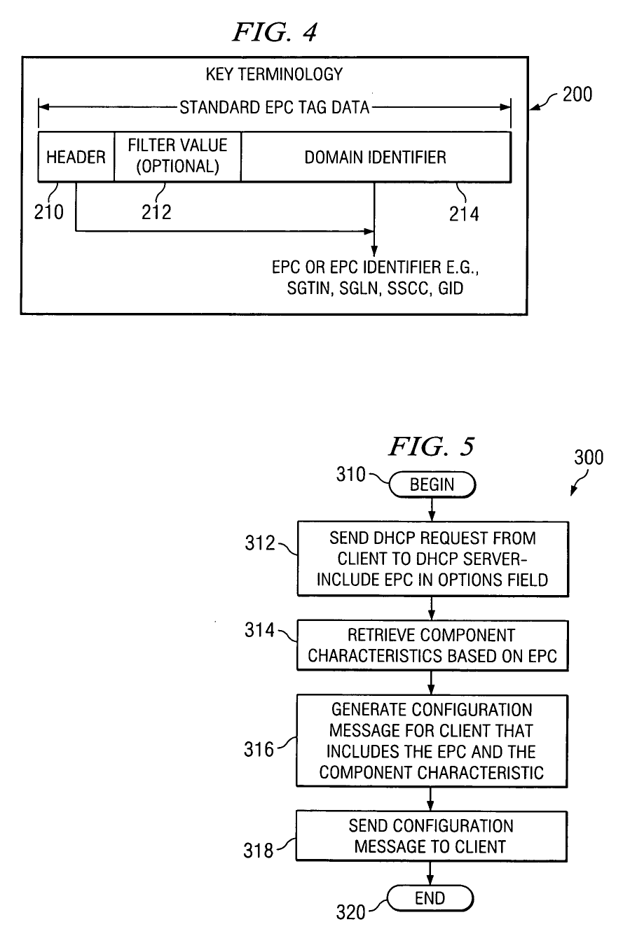

Now referring to FIG. 4 an EPC tag 200 is shown. EPC tag includes header 210, filter value 212 and domain identifier 214.

Now referring to FIG. 5, a flow diagram showing a method according to the present disclosure is shown. The method 300 begins at 310 when a DHCP request is sent from the client component to the DHCP server where the DHCP request includes the client's EPC information within the options field of the DHCP request 312. Next, DHCP server retrieves component characteristics or other authorization information based upon the EPC of the client component 314. Next the DHCP server generates a configuration message for the client that includes the EPC and component characteristics 316. Finally, the configuration message is sent to the client 318 thereby ending the method 320.

The resulting EPC tag 200 may preferably include a General Identifier (GID), a serialized version of the EAN.UCC Global Trade Item Number (GTIN), the EAN.UCC Serial Shipping Container Code (SSCC), the EAN.UCC Global Location Number (GLN), the EAN.UCC Global Returnable Asset Identifier (GRAI), and the EAN.UCC Global Individual Asset Identifier as described in “EPC Generation 1 Tag Data Standards Version 1.1 Rev. 1.27” May 10, 2005, which is hereby incorporated by reference.

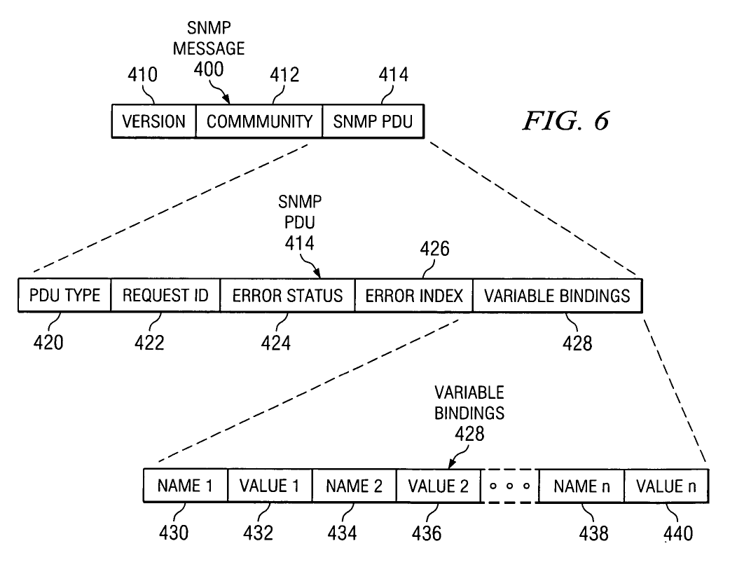

Now referring to FIG. 6, a depiction of an SNMP message 400 is shown. SNMP message 400 generally includes version field 410, community field 412 and SNMP Protocol Data Unit (PDU) 414. SNMP PDUs are preferably encoded in Tag-Length-Value format. SNMP PDU field 414 further includes PDU type field 420, Request ID field 422, error status field 424, error index 426 and variable bindings 428. Variable bindings field 428 further includes first name field 430 and corresponding first value 432, second name field 434 and corresponding second value 436, and continuing on to n^{th} name field 438 and n^{th} value 440.

The general use and application of SNMP message or packet 40 is well known to those of ordinary skill in the art and is discussed in detail herein. However, in a particular embodiment, name field 438 and value 440 may be advantageously utilized to store EPC ID information of an originating device (such as client 16, 18, 20 or 22 as shown in FIG. 1). The EPC ID information may be subsequently correlated with information stored in a database (such as inventory database 30 shown in FIG. 1) to verify the identity or authenticity of the device from which the SNMP packet originates. SNMP packets that have been whose source or authenticity has been identified may be used and/or managed and SNMP packets that cannot be verified or whose EPC data does not match up with information in an associated inventory database may be set aside for review or may be discarded or ignored. This advantageously increases the security capability of the system and increase the systems ability to manage incoming SNMP messages.

In a particular embodiment, clients with SNMP agents are preferably EPC enabled. In operation, the present teachings may be employed without jeopardizing compatibility because the SNMP may be amended to include EPC Identification at the end of the SNMP messages. For example, if a “Set Request” packet is sent, the name 430 of variable binding 428 points to the EPC ID object and value field 432 may be set as the ninety-six bit data of the EPC ID. In a particular embodiment SNMP PDUs 414 are encoded in Tag-Length-Value format such that the protocol stack may need only to parse the approved EPC ID after all standard parameters are processed. The EPC ID may then be used to validate the identity of the sending party by comparing it against inventory database 30.

Although the disclosed embodiments have been described in detail, it should be understood that various changes, substitutions and alterations can be made to the embodiments without departing from their spirit and scope.

What is claimed is:

1. An information handling system comprising:
a management server;
at least one client component in communication with the management server, the client component having an Electronic Protocol Code (EPC) associated therewith;
an inventory database in communication with the management server, the inventory database comprising a listing of a plurality of EPCs and at least one component characteristic associated with each EPC; and
the management server operable to manage the at least one client component based upon the at least one component characteristic associated with the client component EPC.

2. An information handling system according to claim 1 wherein the management server comprises a Dynamic Host Configuration Protocol (DHCP) server.

3. An information handling system according to claim 1 further comprising a plurality of client components in communication with the management server, each client component having an EPC associated therewith.

4. An information handling system according to claim 1 wherein the at least one component characteristic associated with each EPC comprises geographical location information associated with each component.

5. An information handling system according to claim 1 wherein the at least one component characteristic associated with each EPC comprises function information associated with each component.

6. An information handling system according to claim 1 wherein each client component comprises a Radio Frequency Identification (RFID) tag.

7. An information handling system according to claim 6 further comprising an RFID scanner operable to scan the RFID tag of the client server, the RFID scanner in communication with the inventory database.

8. An information handling system according to claim 1 wherein:
the at least one client component is operable to send the management server a request including the associated EPC;
the management node is operable to retrieve the at least one component characteristic associated with the EPC received from the client component from the inventory database; and
the management server operable to generate a configuration message to be sent to the at least one client component, the configuration message incorporating the EPC and the at least one component characteristic.

9. An information handling system according to claim 8 wherein the configuration message comprises a Dynamic Host Configuration Protocol (DHCP) message.

10. An information handling system according to claim 9 wherein the EPC information is provided within an options field within the DHCP message.

11. An information handling system according to claim 8 wherein the client server is operable to incorporate the component characteristic information in the configuration message in network communications.

12. An information handling system according to claim 11 wherein the network communications comprise Simple Network Management Protocol (SNMP) communications.

13. A management server for managing client servers within an information handling system comprising:
an Electronic Product Code coordination module operable to:
communicate with at least one client server in communication therewith, the at least one client server having an Electronic Product Code (EPC) associated therewith;
communicate with an inventory database in communication therewith, the inventory database listing a plurality of EPCs and at least one component characteristic associated with each EPC; and
provide the at least one client server a configuration message incorporating the EPC of the client server and the at least one component characteristic associated with the client server EPC.

14. A management server according to claim 13 wherein the management server comprises a Dynamic Host Configuration Protocol (DHCP) server.

15. A management server according to claim 13 further comprising the EPC coordination module operable to communicate with a plurality of client servers, each client server having an EPC associated therewith.

16. A management server according to claim 13 wherein the EPC coordination module is further operable to:
receive a request from the at least one client server including the associated EPC;
retrieve the at least one component characteristic associated with the EPC received from the client from the inventory database; and
generate a configuration message to be sent to the at least one client server, the configuration message incorporating the EPC and the at least one component characteristic.

17. The management server according to claim 16 wherein the configuration message comprises a Dynamic Host Configuration Protocol (DHCP) message.

18. A method comprising:
sending a request from a client component to a management server, the request including an Electronic Product Code (EPC) associated with the client component;
retrieving at least one component characteristic associated with the EPC associated with the client component; and
generating a configuration message to be sent to the at least one client component, the configuration message incorporating the EPC and the at least one component characteristic.

19. A method according to claim 18 further comprising wherein the configuration message comprises a Dynamic Host Configuration Protocol (DHCP) message.

20. A method according to claim 19 wherein the EPC information is provided within an options field within the DHCP message.
